(19) United States
(12) Patent Application Publication
(10) Pub. No.: US 2009/0120309 A1
(43) Pub. Date: May 14, 2009

(54) IN-LINE MULTI-COLORED CLOTHING PRINTER

(76) Inventor: ALEXANDER SZYSZKO, MURRIETA, CA (US)

Correspondence Address: BUHLER ASSOCIATES;BUHLER, KIRK A., 1101 CALIFORNIA AVE., SUITE 208, CORONA, CA, 92881, US

(21) Appl. No.: 12/267,474

(22) Filed: Nov. 7, 2008

Related U.S. Application Data
(60) Provisional application No. 61/002,678, filed on Nov. 9, 2007.

(51) Int. Cl. B41M 1/14

(52) U.S. Cl. 101/35; 101/211

(57) ABSTRACT

Improvements in printing on shirts are disclosed. The shirt printer incorporates multiple elongated single color print heads arranged in-line. As opposed to using standard three or four colors, the clothing printer uses multiple heads where each print head uses a single specific color to eliminate mixing of the colors to obtain a specific hue. Between each print head, a dryer is placed to ensure each color is dry before the application on a subsequent color is applied. The method reproduces a similar method to clothing that is silk-screened. Clothing is placed on blank clothing holders and passes through the printing machine in an assembly line format. Print heads can be arranged on both sides of the blank clothing holder to allow for simultaneous printing on multiple sides of the clothing. Three printing styles are disclosed for a gauntlet style printers and a barrel style printer.

### CROSS REFERENCE TO RELATED APPLICATION

Not Applicable

This application claims the benefit of Provisional 61/002,678 filed Nov. 9, 2008 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in clothing printing. More particularly, the present clothing printer incorporates multiple elongated single color print heads arranged in an in-line arrangement. As opposed to using standard three or four colors, the clothing printer uses multiple heads where each print head uses a single specific color to eliminate mixing of the colors to obtain a specific hue. Between each print head, a dryer is placed to ensure each color is dry before the application on a subsequent color is applied. The method reproduces a similar method to clothing that is silk-screened. Clothing is placed on blank clothing holders and is passed through the printing machine in an assembly line format. Print heads can be arranged on both sides of the blank clothing holder to allow for simultaneous printing on multiple sides of the clothing.

2. Description of Related Art Including Information Disclosed Under 37 CFR 1.97 and 1.98

The printing on most clothing is performed with a screening process where each color is separated and a negative image of the colored area is placed on a silk screen. A shirt is located onto the printing tray, the sink screen is placed over the shirt and ink is squeezed through the silk screen and embedded into the fabric of the shirt. The shirt is then allowed to dry and is then repeated with another color until all of the desired colors have been printed onto the shirt. More modern shirt printers incorporate three or four color printing heads containing yellow, red, blue and optionally black to print an image onto a shirt using multiple passes.

A number of patents have been issued on ink jet printers that require the print head to make multiple passes over the clothing (shirt) to create the image. Exemplary examples of these patents are U.S. Pat. No. 5,841,549 issued Nov. 24, 1998 to Atsushi Munakaa, U.S. Pat. No. 6,095,628 issued Aug. 1, 2000 to Matthew Rhome and U.S. Pat. No. 6,883,911 issued Apr. 26, 2005 to Akiko Niimi et al. While these three patents disclose a short printing method, all the print heads print on only one shirt at a time. They further require multiple passes over a shirt to produce the image. They only print on one side of a shirt and they require mixing of four colors to achieve the desired color.

A number of patents have also been issued that disclose the method of printing on a shirt and performing the scanning and color separation. Examples of these patents include U.S. Pat. No. 5,396,275 issued to Shoji Koiko et al on Mar. 7, 1995, U.S. Pat. No. 6,705,717 issued on Mar. 16, 2004 to Mijuhki Fujita et al., and U.S. Pat. No. 6,742,869 issued Jun. 1, 2004 to Martin F. Redding et al. These process first input an image into a computer from scanning, creation or data input. Each of the colors is then separated for output to a printer. The printing method is still disclosed as an inkjet type printing process where a print heads makes multiple passes over the shirt to print the image. There is no ability to use custom color inks, print multiple shirts at the same time, to print on both sides of a shirt, or print a shirt with a single pass through the printing process.

What is needed is an in-line printing process that uses multiple elongated single color print heads, single or multiple multi-colored printing head that can print on both sides of a shirt at the same time. The proposed in-line multi-colored clothing printer provides the solution with a printing process that provides the ability to print shirts in a production type printing process where virtually each shirt can have the same or different logo.

### BRIEF SUMMARY OF THE INVENTION

It is an object of the in-line multi-colored clothing printer to where the printing heads are long enough to print each color with a single pass over the shirt. This allows a higher production rate to produce printed shirts. The shirts are placed over a target and moved past the printing heads as opposed to the printing heads moving over the shirt.

It is an object of the in-line multi-colored clothing printer to use custom colors in each printing head to achieve a preferred color match. A customer has the ability to select each specific color as opposed to mixing colors. The application of a single color more closely approximates the printing colors and methods that are used with screening shirts. Since the standard four printing colors of yellow, red, blue and black are replaced with custom colors the printer may have as many as eight or more printing heads.

It is another object of the in-line multi-colored clothing printer to print on each side of a shirt at the same time. Printing on both sides of a shirt more than doubles the number of shirts that can be printed at a single time. Each shirt is loaded only once onto the shirt holder and passed through the printer before it is removed at the end of the process. If the printer only prints on one side of the shirt it must be loaded printed, returned to the starting point, turned over and passed through the printing process a second time before the shirt is removed.

It is still another object of the of the in-line multi-colored clothing is to provide a drying station between each print head to minimize bleeding and mixing of sequential colors that are printed on the shirt. The drying station solidifies the ink thereby bonding it to the fabric or to an underlying layer of ink. The ability to layer different colors is not available when using a four-color ink jet printing process because laying one liquid layer on top of another liquid layer will result in a different color. The first color, possibly black or white as a base, is printed and dried prior to printing other colors onto the fabric. Using the in-line printing process with dryers allows the same color to be printed onto clothing on several different layers.

Various objects, features, aspects, and advantages of the present in-line multi-colored clothing printer will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a flow chart for separating the colors and creating the printing sequence.

FIG. 2 shows an isometric view of horizontal in-line gauntlet printer.

FIG. 3 shows an isometric view of vertical in-line gauntlet printer.

FIG. 4 shows an isometric view of a barrel type shirt printer.

FIG. 5 shows an isometric view of the array of color dispensers in a first preferred embodiment.

FIG. 6 shows an isometric view of the array of color dispensers in a second preferred embodiment.

### DETAILED DESCRIPTION OF THE INVENTION

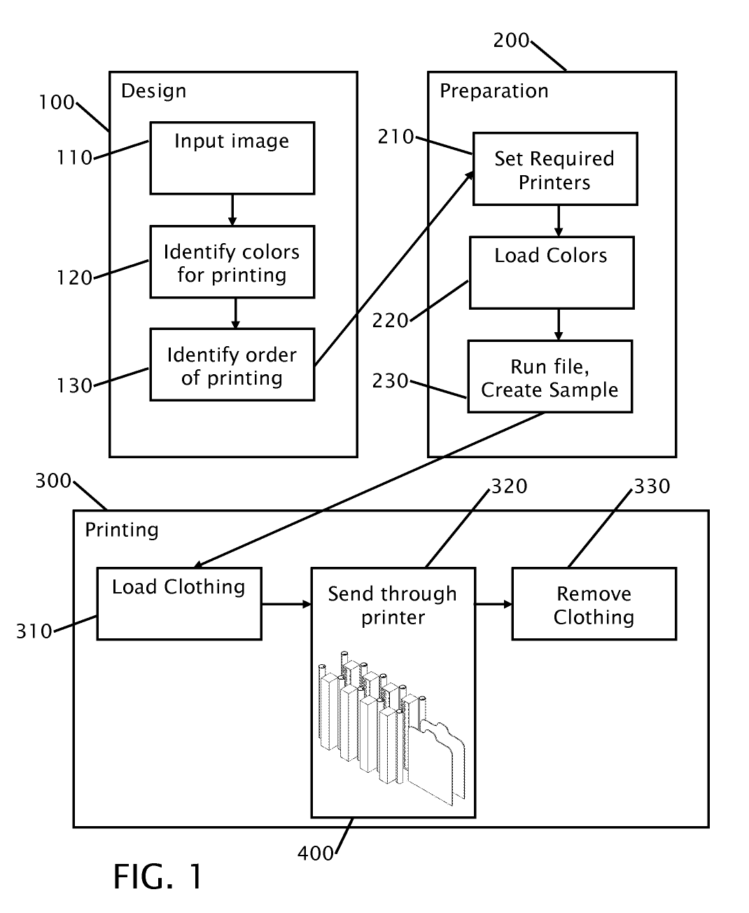

FIG. 1 shows a flow chart for separating the colors and creating the printing sequence. The process begins with the design 100 of the article of clothing. While the article of clothing is identified as a shirt, other articles of clothing are contemplated including but not limited to pants, scarf's, hats, caps, bandanas, jackets, coats sweaters, belts and ties. The design is input into a computer as an image and or text file 110. Each image is created from one or more colors and a computer program separates the colors. When clothing was made with silk-screening a separate screen or mask was made for each color. The process is similarly performed where the computer separates the colors and identifies the colors to be printed and where they will be placed on each article of clothing 120. The order for each printed color is identified 130. For example, the first color could be black or white as a background for the reaming colors. The design is then passed to the preparation stage 200.

In the preparation stage, the number of colors is determined based upon the number of colors that are selected 210. It is contemplated that the number of print heads that are required could be as few as one to six or more print heads. In the embodiments shown four sets of printing heads are shown and described but more or less than four heads are contemplated. It is further contemplated that the printing system in flexible to add or remove printing stations as required based upon the printing job. The individual colors are loaded into each print head 220 and the program is operated to create and sample to verify that the printing will be acceptable 230. Once the printing is accepted, production will begin 300.

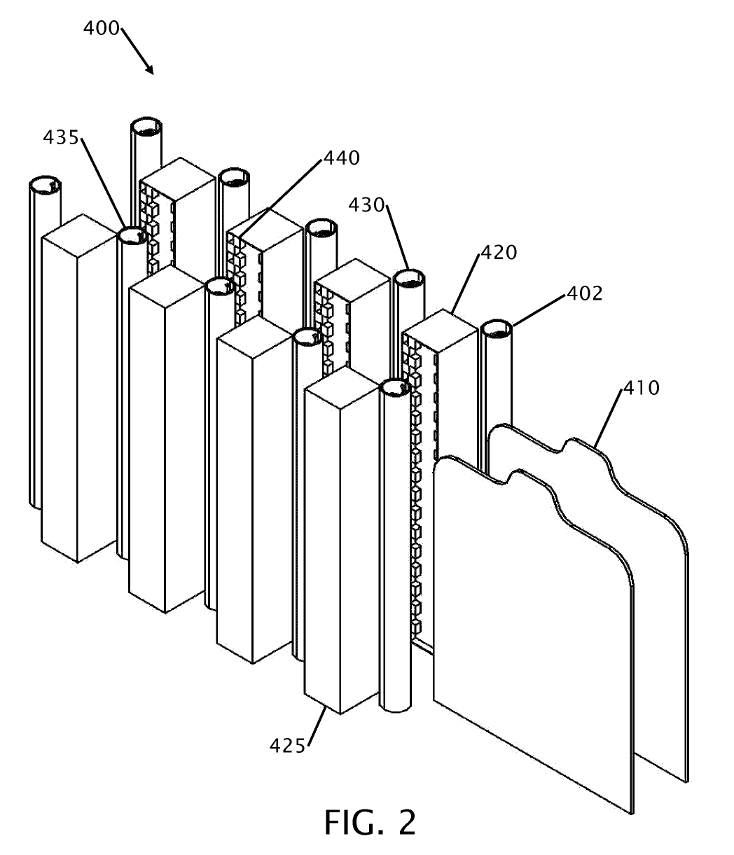

Productions 300 consists of loading shirts onto or over target or platen blanks or fixture 310, sending them through the printer 320 past the print head(s) 400 and removing 330 the printed clothing. The printing machine will be shown and described in more detail with FIGS. 2, 3 and 4.

FIG. 2 shows an isometric view of horizontal in-line gauntlet printer 400. The gauntlet style printer has print heads arranged on each side of the shirt blank 410 to print on both sides of the shirt on the same side. In operation a shirt is loaded onto the platen, blank or target 410. The blank or target may have a fixed dimension or may expand to bring the surface of the shirt to the desired distance from the print heads. It is also contemplated that the blank can collect excess material to ensure the shirt is held against the target 410. It is further contemplated that multiple blanks 410 are used so one shirt can be loaded, while one is being printed, while still another shirt is being removed. The machine has one or more print heads 420 and 425 placed on each side of the shirt where each head is a different color or a multi-colored print head. Various printing technologies are contemplated for the print heads 440 including but not limited to ink jet, Piezo, thermal, laser print, laser discharge, laser etching, laser cutting, laser engraving, ink jet hot melt ink, air brush, dispensing unit (have viscosity paste), chemical discharge and etching.

Each print head is sufficiently long to print entire image with a single pass. It is contemplated to utilize a single long head for the print head to be made from a number of smaller heads that are configured in an end-to-end orientation. Prototypes have been made by stacking six or more print heads to achieve a printing head that is 16 to 24 inches in length. After each print head, a treatment station 430 and 435 is located. In one embodiment a pre-treatment station 402 is contemplated before the first printing station. The treatment station cures or dries the printed image. It is contemplated that the treatment station(s) 430 and 435 include but not be limited to chemical treatment, energy transfer: conventional heat, air forced hot or cold, ionizations, infrared wave, UV light, laser cure CO2 and YAK.

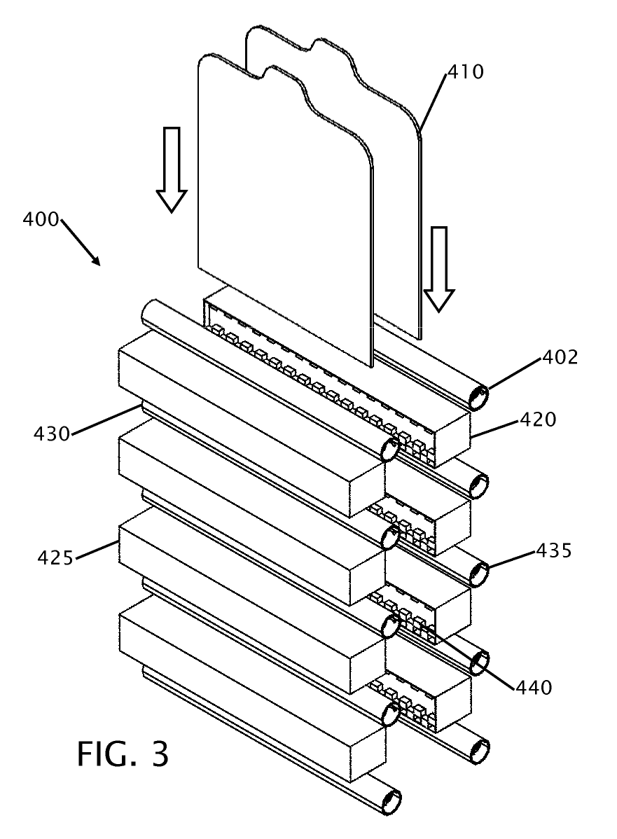

FIG. 3 shows a printing configuration where the clothing or targets 410 are passed in a vertical orientation through the print heads 420 and 425 as well as past the treatment stations 402, 430 and 435. This arrangement allows for a narrower arrangement of printing because shirts, for example, are usually taller as opposed to wider.

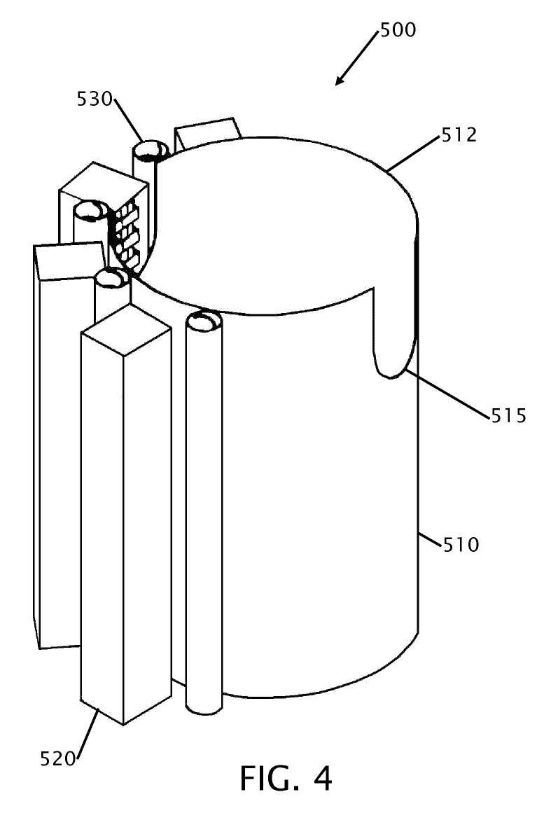

FIG. 4 shows an isometric view of a barrel type shirt printer 500. In this embodiment, a shirt is placed over the top edge 512 of the barrel 510. The arms of the shirt are placed thought the side slots 515. The barrel is revolved so the outer surface of the shirt passes the print heads 520. In the embodiment shown four elongated printing heads 520 are shown with four treatment stations 530. The elongated printing stations heads 520 and the treatment stations 530 are similar in configuration to the stations described in FIGS. 2 and 3. In this embodiment, a single shirt can be rotated only 180 degrees past the print heads to print an image or rotated 360 degrees to print on both sides of the shirt. It is also contemplated that print heads and treatment heads can be placed on both sides of the barrel and a rotation of 180 degrees will print on both sides of a shirt.

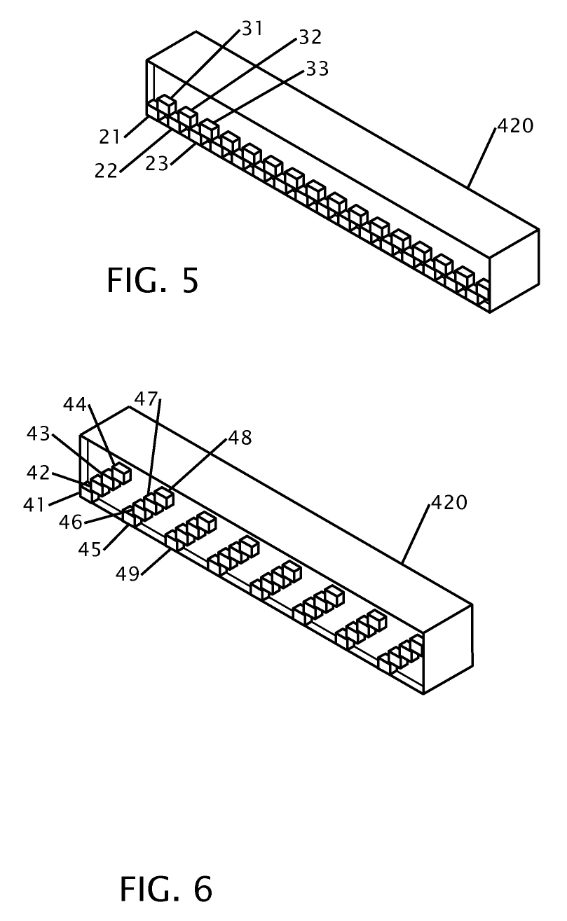

FIG. 5 shows an isometric view of the array of color dispensers in a first preferred embodiment. In this embodiment, the printing station 420 uses multiple single color banks where the printing banks 21-23 etc and 31-33 etc are placed in a staggered array such that complete coverage of the area to be printed is achieved.

FIG. 6 shows an isometric view of the array of color dispensers in a second preferred embodiment. In this embodiment, each printing station 420 has a staggered array of printing banks 40-49 etc to provide a complete coverage of the article of clothing or target.

Thus, specific embodiments of an in-line multi-colored clothing printer have been disclosed. It should be apparent, however, to those skilled in the art that many more modifications besides those described are possible without departing from the inventive concepts herein. The inventive subject matter, therefore, is not to be restricted except in the spirit of the appended claims.

1. An in-line multicolored clothing printer comprising:
at least one fixed printing head arranged in an elongated printing bank;
a target or platen fixture for temporally retaining an article to be printed;
a transportation mechanism for controllably moving said target past said elongated bank in a single pass such that all printing from said at least one fixed head is deposited on said article in a linear path, and
a controller that controls dispensing of color from said at least one elongated printing bank and movement of said transportation mechanism.

2. The according to claim 1 wherein said multiple fixed printing heads arranged in an elongated bank are used where each of said fixed printing heads provide a different color of print.

3. The according to claim 1 that further includes a treatment station after said at least one fixed printing head arranged in an elongated bank.

4. The according to claim 1 wherein said printing process is from ink jet, Piezo, thermal, laser print, laser discharge, laser etching, laser cutting, laser engraving, ink jet hot melt ink, air brush, chemical discharge or etching.

5. The according to claim 3 wherein said treatment station is from chemical treatment, energy transfer: conventional heat, air forced hot or cold, ionizations, infrared wave, UV light, laser cure CO2 or YAK.

6. The according to claim 1 wherein said target or platen fixture is for temporally retaining an article of clothing.

7. The according to claim 1 wherein said printing head in said elongated printing bank includes a plurality of print separate printing elements arranged in a staggered array.

8. The according to claim 2 wherein said controller separates multiple colors and color combinations that are dispensed from each of said different colored elongated banks.

9. The according to claim 2 wherein said multiple fixed printing heads are arranged in a horizontal array.

10. The according to claim 2 wherein said multiple fixed printing heads are arranged in a vertical array.

11. A rotary multicolored clothing printer comprising:
at least one fixed printing head arranged in an elongated printing bank;
a target or platen fixture for temporally retaining an article to be printed;
a transportation mechanism for controllably turning said target past said elongated printing bank in a single arced rotation such that all printing from said at least one fixed head is deposited on said article in said arced rotation, and
a controller that controls dispensing of color from said at least one elongated printing bank and movement of said transportation mechanism.

12. The according to claim 11 wherein said multiple fixed printing heads arranged in an elongated bank are used where each of said fixed printing heads provide a different color of print.

13. The according to claim 11 that further includes a treatment station after said at least one fixed printing head arranged in an elongated bank.

14. The according to claim 11 wherein said printing process is from ink jet, Piezo, thermal, laser print, laser discharge, laser etching, laser cutting, laser engraving, ink jet hot melt ink, air brush, chemical discharge or etching.

15. The according to claim 13 wherein said treatment station is from chemical treatment, energy transfer: conventional heat, air forced hot or cold, ionizations, infrared wave, UV light, laser cure CO2 or YAK.

16. The according to claim 11 wherein said target or platen fixture is for temporally retaining an article of clothing.

17. The according to claim 11 wherein said printing head in said elongated printing bank includes a plurality of print separate printing elements arranged in a staggered array.

18. The according to claim 12 wherein said controller separates multiple colors and color combinations that are dispensed from each of said different colored elongated banks.

19. The according to claim 12 wherein said multiple fixed printing heads are arranged in an array around said arced rotation.

20. The according to claim 12 wherein said multiple fixed printing heads are arranged in opposing sides of said arced array.
